(19) United States
(12) Patent Application Publication
(10) Pub. No.: US 2026/0268160 A1
(43) Pub. Date: Sep. 10, 2026

(54) METHOD AND SYSTEM FOR PERFORMING VISION TASK USING PRE-TRAINED VISION-LANGUAGE TRANSFORMER

(71) Applicant: LG MANAGEMENT DEVELOPMENT INSTITUTE CO., LTD., Seoul (KR)

(72) Inventors: Seung Hwan KIM, Seongnam-si (KR); Jin Hyung KIM, Daejeon (KR); Bum Soo KIM, Seoul (KR); Yeon Sik JO, Seoul (KR)

(21) Appl. No.: 19/534,468

(22) Filed: Feb. 9, 2026

Related U.S. Application Data
(63) Continuation of application No. 19/321,706, filed on Sep. 8, 2025.
Application No. 19/321,706 is a continuation of application No. PCT/KR2024/003118, filed on Mar. 11, 2024.

(30) Foreign Application Priority Data
Mar. 9, 2023 (KR) 10-2023-0030861

(51) Int. Cl. G06N 3/096; G06N 3/045; G06T 11/60

(52) U.S. Cl. CPC G06N 3/096; G06N 3/045; G06T 11/60

(57) ABSTRACT

The present disclosure relates to a method and a system for promptly training a simplified vision-language transformer, in which large uncurated datasets are augmented (e.g., through image enlargement and/or masking, etc.) and vision-language transformers are pre-trained by reflecting, through a knowledge distillation framework, misaligned information between an augmented image and text upon the augmentation, thereby reducing both the necessary size of the utilized data set and data processing overhead.

### CROSS REFERENCE TO RELATED APPLICATION

This application is a continuation of U.S. patent application Ser. No. 19/321,706, filed on Sep. 8, 2025, which is a Bypass Continuation of International Patent Application No. PCT/KR2024/003118, filed on Mar. 11, 2024, which claims priority from and the benefit of Korean Patent Application No. 10-2023-0030861, filed on Mar. 9, 2023, which is hereby incorporated by reference for all purposes as if fully set forth herein.

### BACKGROUND

### Field

Embodiments of the invention relate generally to a method for pre-training a transformer with vision and language data, an artificial intelligence system including a vision transformer pre-trained by the method, and a method and system for performing a vision task using the pre-trained vision-language transformer.

### Discussion of the Background

Recently, with the emergence of vision-language pretraining (VLP) models pre-trained on large-scale general domain data, AI-based computer vision processing technology has been rapidly developing.

In particular, vision transformers trained on large-scale image-text data sets using technologies such as global self-attention and contrastive language-image pretraining (CLIP), as in Patent Art Literature 1, which describes learning directly from raw text about images, have illustrated innovative progress in downstream tasks such as various and difficult vision tasks.

However, in order to fully train global self-attention, which is mainly driven by vision transformers, a large-scale data set is required, and there is a problem of excessive data processing overhead.

In order to secure such a large data set, many methods are used to secure various data by augmenting language data or/and vision data. These include, for example, randomly applying rotation, flipping, resizing, cropping, color adjustment, enlargement, cropping, and adding Gaussian noise to an existing image.

During the process of augmenting the image, particularly, if a specific area is randomly enlarged or reduced, cropped, or the like, a misalignment problem occurs where text matched to the image that is the original augmentation target does not match well to the augmented image.

In addition, if the vision-language transformer is pre-trained in the conventional way based on the pair of texts that matched the pre-augmented image and the misaligned augmented image, the final performance of the pre-trained vision-language transformer can be disappointing.

To overcome these problems, improved versions of Prior Art Literature 1 have been developed. Prior Art Literature 2 has proposed a technique to introduce an additional external module that detects misalignment through an object detector and corrects the text through a summary extractor when misalignment is detected, and Prior Art Literature 3 has proposed a technique to match the alignment during pre-training through station embedding. However, when using the external module as described above, there is a problem that the amount of data processing increases, and pre-training can then place a large burden on resources.
(Prior Art Literature 1): Alec Radford, Jong Wook Kim, Chris Hallacy, Aditya Ramesh, Gabriel Goh, Sandhini Agarwal, Girish Sastry, Amanda Askell, Pamela Mishkin, Jack Clark, Gretchen Kruegerand Ilya Sutskever, Learning Transferable Visual Models From Natural Language Supervision, arXiv.2103.00020 (26 Feb. 2021).
(Prior Art Literature 2): Yuting Gao, Jinfeng Liu, Zihan Xu, Jun Zhang, Ke Li, and Chunhua Shen, PyramidCLIP: Hierarchical feature alignment for vision-language model pretraining, arXiv: 2204.14095v2 (28 May 2022)
(Prior Art Literature 3): Janghyeon Lee, Jongsuk Kim, Hyounguk Shon, Bumsoo Kim, Seung Hwan Kim, Honglak Lee and Junmo Kim, UniCLIP: Unified framework for contrastive language-image pretraining, arXiv: 2209.13430v2 (31 Oct. 2022); also in Advances in Neural Information Processing Systems 35 (NeurIPS 2022).

There is a need in the art for a method for pre-training a vision language transformer, wherein the method exhibits improved efficiency by reducing the necessary amount of data processing and eliminating the need to use an external module.

The above information disclosed in this Background section is only for understanding of the background of the inventive concepts, and, therefore, it may contain information that does not constitute prior art.

### SUMMARY

An object of a method for pre-training a vision-language transformer according to the present disclosure is to secure pre-training data of a plurality of image-text pairs by randomly enlarging or masking a plurality of image data required for pre-training.

Additional features of the inventive concepts will be set forth in the description which follows, and in part will be apparent from the description, or may be learned by practice of the inventive concepts.

Another object of the method for pre-training a vision-language transformer according to the present disclosure is to teach the vision-language transformer by utilizing as useful information the misalignment of image-text pairs that occurs when randomly enlarging or masking images.

Still another object of the present disclosure is to develop an artificial intelligence system that can effectively perform various vision tasks using the vision-language transformer pre-trained in this way.

A method for pre-training a vision-language transformer according to various embodiments of the present disclosure proposes randomly augmenting an image to intentionally induce a misalignment between the augmented image and the corresponding text, and pre-training the vision-language transformer by using the misaligned image and text data as useful information.

In detail, the inventive method for pre-training a vision-language transformer according to various embodiments of the present disclosure proposes a contrast image-text pre-training method (Misalign, Contrast then Distill: MCD, hereinafter “MCD pre-training method”) using knowledge distillation that can pre-train by utilizing the misaligned image and text data of the augmented image-text pair as useful information.

In one aspect, according to various embodiments of the present disclosure, there is provided a method for performing a vision task using a pre-trained vision-language transformer, the vision task being performed by a computing device, the method comprising: receiving an analysis target image from a user terminal; performing the vision task based on the analysis target image using the pre-trained vision-language transformer; and outputting a performance result of the vision task through the user terminal.

In some embodiments, a method for pre-training the vision-language transformer can further include obtaining a dataset including a plurality of original image-text pairs in which a plurality of original images and a plurality of texts are matched to each other, generating a plurality of augmented images by augmenting the plurality of original images, and pre-training the vision-language transformer in a manner of knowledge-distilling recognition of a teacher model on a ratio of similarity of the plurality of original images to the plurality of texts and similarity of the plurality of augmented images to the plurality of texts into a student model.

In some embodiments, the method can further comprise receiving a user input including at least one of voice or text, wherein the performing of the vision task includes performing vision-language analysis on the analysis target image and the user input using the vision-language transformer, and performing the vision task based on a vision-language analysis result.

In some embodiments, the receiving of the analysis target image, the receiving of the user input, and the performing of the vision task can be performed through any one of a chatbot application, an image processing application, a text message application, an email application, a dictation application, a virtual keyboard application, and a browser application executed through the computing device.

In some embodiments, the vision task can include at least one of visual question answering (VQA), image classification, object detection, image segmentation, image captioning, image analysis, and optical character recognition (OCR).

In some embodiments, the pre-training of the vision-language transformer can include inputting text matched to the original image into a text encoder to output text feature vector representations, inputting the original image and the plurality of augmented images into a teacher image encoder to output first image feature vector representations, inputting the original image and the plurality of augmented images into a student image encoder to output second image feature vector representations, generating a first alignment matrix for the text feature vector representations and the first image feature vector representations, learning the first alignment matrix so that the text feature vector representations and the first image feature vector representations are aligned to have similarity according to a positive and negative mapping relationship of the image-text pair, generating a second alignment matrix for the text feature vector representations and the second image feature vector representations, and performing knowledge distillation on a student image encoder by aligning the second alignment matrix so as to predict the output of the learned first alignment matrix.

In some embodiments, the learning of the first alignment matrix so that the text feature vector representations and the first image feature vector representations are aligned can include determining a positive feature vector representation pair and a negative feature vector representation pair between the text feature vector representations and the first image feature vector representations according to a mapping relationship between the original image-text pair and the augmented image-text pair, and learning the teacher image encoder according to a loss function that makes a distance between the positive feature vector representation pairs closer and a distance between the negative feature vector representation pairs farther for similarity alignment.

In some embodiments, the learning of the encoders according to the loss function can include applying a momentum stop gradient to the teacher image encoder to block backpropagation during learning for similarity alignment according to the loss function.

In some embodiments, the performing of the knowledge distillation on the student image encoder can include performing knowledge distillation so that the output value of the first alignment matrix according to the similarity alignment is predicted by the second alignment matrix.

In some embodiments, the performing of the knowledge distillation on the second alignment matrix can include blocking backpropagation to the text encoder during the knowledge distillation.

In some embodiments, the performing of the knowledge distillation on the second alignment matrix can include performing knowledge distillation so that a parameter of the second alignment matrix follows a parameter of the first alignment matrix.

In some embodiments, the performing of the knowledge distillation so that the parameter of the second alignment matrix follows the parameter of the first alignment matrix can include updating the parameter of the first alignment matrix with an exponential moving average (EMA) based on the parameter of the second alignment matrix.

In some embodiments, the performing of the knowledge distillation on the second alignment matrix can include defining a loss function that reflects misalignment information between the augmented image and the text through a distance between the first image feature vector representation and the text feature vector representation and a distance between the second image feature vector representation and the text feature vector representation.

In some embodiments, the performing of the knowledge distillation by defining the loss function based on the distances can include calculating a first Euclidean distance between the original image feature vector representation output by the student image encoder and the text feature vector representation, and a second Euclidean distance between the augmented image feature vector representation output by the student image encoder and the text feature vector representation and calculating a first log ratio that calculates a ratio of the first Euclidean distance and the second Euclidean distance in a log scale, and calculating a third Euclidean distance between the original image feature vector representation output by the teacher image encoder and the text feature vector representation, and a fourth Euclidean distance between the augmented image feature vector representation output by the teacher image encoder and the text feature vector representation, and calculating a second log ratio that calculates a ratio of the third Euclidean distance and the fourth Euclidean distance in a log scale.

In some embodiments, the performing of the knowledge distillation by defining the loss function based on the distances can include performing the knowledge distillation by defining a difference between the first log ratio and the second log ratio as a loss function for aligning the second alignment matrix to be approximate to the first alignment matrix.

In some embodiments, the loss function for aligning the first alignment matrix and the second alignment matrix can be defined as

$$\text{?} = {‖ log \frac{D ( \text{?} , \text{?} )}{D ( \text{?} , \text{?} )} - log \frac{D ( \text{?} , \text{?} )}{D ( \text{?} , \text{?} )} ‖}_{\text{?}} .$$

$$\text{?} \text{indicates text missing or illegible when filed}$$

In some embodiments, the augmenting of the plurality of original images can include randomly applying at least one of rotation, flipping, resizing, cropping, color adjustment, enlargement and adding Gaussian noise.

In some embodiments, the pre-training step can utilize a misalign, contrast then distill (MCD) method for image-text pre-training.

In some embodiments, the computing device can be at least one of a smart phone, a mobile phone, a digital broadcasting device, a personal digital assistant (PDA), a portable multimedia player (PDP), a desktop, a wearable device, an embedded computing device and a tablet PC.

In some embodiments, the computing device can comprise a processor that is composed of at least one of a central processing unit (CPU), a graphics processing unit (GPU), application specific circuits (ASICs), digital signal processors (DSPs), digital signal processing devices (DSPDs), programmable logic devices (PLDs), field programmable gate arrays (FPGAs), controllers, micro-controllers, microprocessors and a plurality of processors electrically connected to each other.

In another aspect, the present invention provides a system for performing a vision task, the system comprising: at least one memory; and at least one processor that reads out one instruction stored in the memory and performs the vision task using a pre-trained vision-language transformer, wherein the at least one processor receives an analysis target image from a user terminal, performs the vision task based on the analysis target image using the pre-trained vision-language transformer, and outputs a performance result of the vision task through the user terminal.

Some embodiments of system for performing a vision task, a method for pre-training the vision-language transformer can include obtaining a dataset including a plurality of original image-text pairs in which a plurality of original images and a plurality of texts are matched to each other, generating a plurality of augmented images by augmenting the plurality of original images, and pre-training the vision-language transformer in a manner of knowledge-distilling recognition of a teacher model on a ratio of similarity of the plurality of original images to the plurality of texts and similarity of the plurality of augmented images to the plurality of texts into a student model.

In still another aspect, a computer-implemented method for performing a vision task includes: outputting to the user interface a first vision feature vector representation by inputting via the user interface at least one piece of vision data and at least one augmented data based on the at least one piece of vision data into at least one artificial intelligence model, outputting to the user interface a second vision feature vector representation from which a portion of image information having relatively low information importance is removed by inputting via the user interface the at least one piece of vision data and the at least one augmented data into at least one artificial intelligence model comprising a token sparsification layer, generating a first alignment matrix for a text feature vector representation for text mapped to the at least one piece of vision data and the first vision feature vector representation, training the first alignment matrix so that the text feature vector representation and the first vision feature vector representation are aligned to have similarity according to positive and negative mapping relationships of the image-text pair, generating a second alignment matrix for the text feature vector representation and the second vision feature vector representation, and performing knowledge distillation on the at least one artificial intelligence model comprising the token sparsification layer by aligning the second alignment matrix to predict the output of the trained first alignment matrix.

In some embodiments of the method for performing a vision task, outputting of a second vision feature vector representation may comprise acquiring output tokens generated by performing an attention operation on image patch tokens by inputting the at least one piece of vision data and the at least one augmented data into the at least one artificial intelligence model, performing token sparsification by removing tokens having low importance at a fixed ratio by the token sparsification layer based on the output tokens from the at least one artificial intelligence model, and outputting the second vision feature vector representation based on the tokens remaining after said token sparsification process.

In some embodiments, the method for performing a vision task may further comprise generating the at least one augmented data by randomly augmenting the at least one piece of vision data and outputting the text feature vector representation by inputting text mapped to the at least one piece of vision data into at least one artificial intelligence model.

In some embodiments of the method for performing a vision task, the outputting of a first vision feature vector representation may comprise outputting a first vision feature vector representation by inputting the at least one piece of vision data and the at least one augmented data to a plurality of self-attention layers and a plurality of feed-forward network layers.

In some embodiments of the method for performing a vision task, the training of the first alignment matrix may include determining a positive feature vector representation pair and a negative feature vector representation pair between the text feature vector representation and the first vision feature vector representation according to a mapping relationship between the at least one piece of vision data-text pair and the at least one augmented data-text pair, and training the at least one artificial intelligence model outputting the first vision feature vector representation according to a loss function that makes a distance between the positive feature vector representation pair closer and a distance between the negative feature vector representation pair farther for similarity alignment.

In some embodiments of the method for performing a vision task, the training of the at least one artificial intelligence model outputting the first vision feature vector representation according to the loss function may include preventing backpropagation by applying a momentum stop gradient to the at least one artificial intelligence model that outputs the first vision feature vector representation during training for similarity alignment according to the loss function.

In some embodiments of the method for performing a vision task, the performing of the knowledge distillation on the at least one artificial intelligence model comprising the token sparsification layer may include performing knowledge distillation so that the output value of the first alignment matrix according to the similarity alignment may be predicted by the second alignment matrix.

In some embodiments of the method for performing a vision task, the performing of the knowledge distillation on the second alignment matrix may include blocking backpropagation to the at least one artificial intelligence model that outputs the text feature vector representation by receiving text mapped to the at least one piece of vision data during the knowledge distillation.

In some embodiments of the method for performing a vision task, the performing of the knowledge distillation on the second alignment matrix may include performing knowledge distillation so that a parameter of the second alignment matrix follows a parameter of the first alignment matrix.

In some embodiments of the method for performing a vision task, the performing of the knowledge distillation so that the parameter of the second alignment matrix follows the parameter of the first alignment matrix may include updating the parameter of the first alignment matrix with an exponential moving average (EMA) based on the parameter of the second alignment matrix.

In some embodiments of the method for performing a vision task, the performing of the knowledge distillation on the second alignment matrix may include defining a loss function that reflects misalignment information between the at least one augmented data and the text through a distance between the first vision feature vector representation and the text feature vector representation and a distance between the second image feature vector representation and the text feature vector representation.

In some embodiments of the method for performing a vision task, the performing of the knowledge distillation by defining the loss function based on the distances may include calculating a first Euclidean distance between the vision data feature vector representation output by the at least one artificial intelligence model comprising the token sparsification layer and the text feature vector representation, and a second Euclidean distance between the augmented data feature vector representation output by the at least one artificial intelligence model comprising the token sparsification layer and the text feature vector representation, and calculating a first log ratio that calculates a ratio of the first Euclidean distance and the second Euclidean distance in a log scale.

In some embodiments of the method for performing a vision task, the performing of the knowledge distillation by defining the loss function based on the distances may include calculating a third Euclidean distance between the vision data feature vector representation output by the at least one artificial intelligence model that outputs the first vision feature vector representation and the text feature vector representation, and a fourth Euclidean distance between the augmented data feature vector representation output by the at least one artificial intelligence model that outputs the first vision feature vector representation and the text feature vector representation, and calculating a second log ratio that calculates a ratio of the third Euclidean distance and the fourth Euclidean distance in a log scale.

In some embodiments of the method for performing a vision task, the performing of the knowledge distillation by defining the loss function based on the distances may include performing the knowledge distillation by defining a difference between the first log ratio and the second log ratio as a loss function for aligning the second alignment matrix to be approximate to the first alignment matrix.

In some embodiments of the method for performing a vision task, the loss function for aligning the first alignment matrix and the second alignment matrix may be defined as

$$\text{?} = {‖ log \frac{D ( \text{?} , \text{?} )}{D ( \text{?} , \text{?} )} - log \frac{D ( \text{?} , \text{?} )}{D ( \text{?} , \text{?} )} ‖}_{\text{?}} .$$

$$\text{?} \text{indicates text missing or illegible when filed}$$

In another aspect, the present invention may provide a method comprising: storing raw user data, input through the at least one user interface, in the at least one memory, ingesting at least one data representation into at least one artificial intelligence model, wherein the at least one data representation may comprise at least one of the raw user data itself or data derived from the raw user data by a pre-processing module, a feature extraction module, or another component configured to generate said data representation, generating vision task data by performing a vision task based on the data representation using the at least one artificial intelligence model that is pre-trained, wherein the vision task is performed by the at least one processor, and ingesting the vision task data into at least one post-processing component, wherein the at least one artificial intelligence model is pre-trained through a pre-training method comprising inputting at least one vision data and at least one augmented data based on the at least one vision data into the at least one artificial intelligence model, and outputting a plurality of types of feature vector representations by the at least one artificial intelligence model, wherein the generating vision task data may comprise inputting the at least one data representation into the at least one artificial intelligence model comprising at least one attention layer, which is operated by said at least one processor, and performing token processing based on the at least one data representation by the at least one artificial intelligence model which is operated by the at least one processor.

In some embodiments, the latter method may further comprise manifesting the vision task data through at least one user interface by the post-processing component which is operated by the at least one processor.

In some embodiments of the latter method, wherein the at least one artificial intelligence model that is pre-trained is pre-trained by a method that includes being trained as a pair of at least two different artificial intelligence models, the vision task may further include an additional task processed by at least one artificial intelligence model based on vision task data accepted from the at least one post-processing component, and the artificial intelligence model that processes the additional task may include at least one of the at least one artificial intelligence model used in the ingesting at least one data representation step.

In some embodiments of the latter method, the performing token processing may comprise performing at least one of pruning or sparsification on tokens having relatively low importance of the at least one data representation.

In some embodiments of the latter method, said raw user data may comprise at least one of user input data comprising at least one of voice or text, and at least one vision data.

In some embodiments of the latter method, the vision task may include at least one of visual question answering (VQA), image classification, object detection, image segmentation, image captioning, image analysis, and optical character recognition (OCR).

In some embodiments of the latter method, the pre-training method may comprise outputting a first vision feature vector representation by inputting at least one piece of vision data and at least one augmented data based on the at least one piece of vision data into at least one artificial intelligence model, outputting a second vision feature vector representation from which a portion of image information having relatively low information importance is removed by inputting the at least one piece of vision data and the at least one augmented data into at least one artificial intelligence model comprising a token sparsification layer, generating a first alignment matrix for a text feature vector representation for text mapped to the at least one piece of vision data and the first vision feature vector representation, training the first alignment matrix so that the text feature vector representation and the first vision feature vector representation are aligned to have similarity according to positive and negative mapping relationships of the image-text pair, generating a second alignment matrix for the text feature vector representation and the second vision feature vector representation, and performing knowledge distillation on the at least one artificial intelligence model comprising the token sparsification layer by aligning the second alignment matrix to predict the output of the trained first alignment matrix.

According to the method for pre-training a vision-language transformer of various embodiments of the present disclosure, it is possible to randomly augment an image to expand the plurality of misaligned image-text pairs into pre-training data, thereby easily securing a large number of pre-training data that includes information that is useful in various aspects.

In addition, according to the method for pre-training a vision-language transformer of various embodiments of the present disclosure, it is possible to provide a vision-language transformer with improved performance through an MCD pre-training method that can learn misalignment of augmented image-text pairs, where the misaligned pairs serve as useful information.

In addition, according to the artificial intelligence system including the vision-language transformer pre-trained according to various embodiments of the present disclosure, it is possible to effectively perform vision tasks such as image classification, object detection, image segmentation, image captioning, image analysis, and optical character recognition by using the vision-language transformer taught with pre-training data that is significantly diverse.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and, together with the description, serve to explain the inventive concepts.

FIG. 1 illustrates an example of a block diagram of a computing system that executes an MCD pre-training method according to one embodiment of the present disclosure.

FIG. 2 illustrates an example of a block diagram of a computing device that pre-trains a vision-language transformer according to the MCD pre-training method according to one embodiment of the present disclosure and executes the pre-trained vision-language transformer.

FIG. 3 illustrates an example of a block diagram of another aspect of a computing device that performs the MCD pre-training method according to one embodiment of the present disclosure and executes the pre-trained vision-language transformer.

FIG. 4 conceptually illustrates a framework of the MCD pre-training method according to one embodiment of the present disclosure.

FIG. 5 illustrates a meta-architecture of the framework of the MCD pre-training method according to one embodiment of the present disclosure.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The present disclosure may be subjected to various transformations and have various embodiments, and specific embodiments are illustrated in the drawings and described in detail in the detailed description. The effects and features of the present disclosure and the methods for achieving them will become clear with reference to the embodiments described in detail below together with the drawings. However, the present disclosure is not limited to the embodiments disclosed below and may be implemented in various forms. In the embodiments below, terms such as first, second, or the like are not used in a limited sense but are used for the purpose of distinguishing one component from another component. In addition, singular expressions include plural expressions unless the context clearly indicates otherwise. In addition, terms such as include or have mean that a feature or component described in the specification exists, and do not preemptively exclude the possibility that one or more other features or components may be added. In addition, in the drawings, the sizes of components may be exaggerated or reduced for convenience of explanation. For example, the sizes and thicknesses of each component illustrated in the drawings are arbitrarily illustrated for convenience of explanation, and therefore the present disclosure is not necessarily limited to what is illustrated.

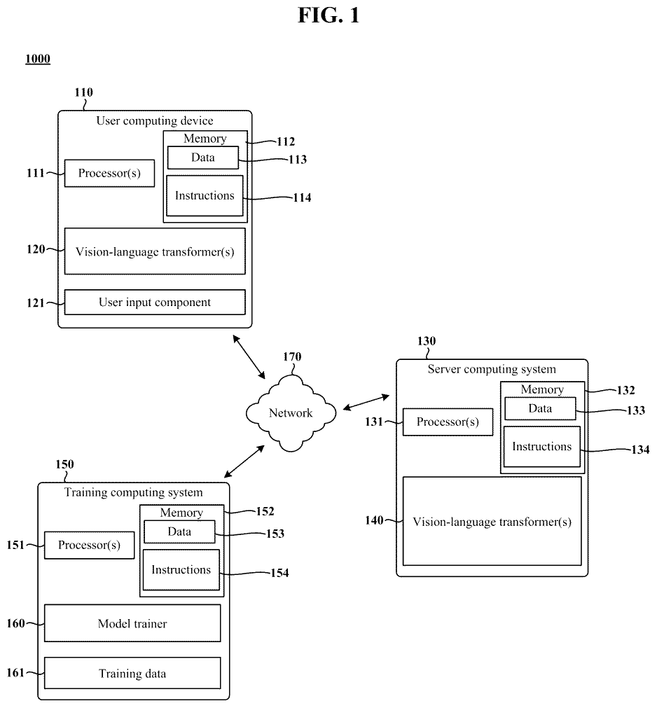

FIG. 1 illustrates an example of a block diagram of a computing system that executes an MCD pre-training method according to one embodiment of the present disclosure.

Referring to FIG. 1, a computing system 1000 according to one embodiment of the present disclosure includes a user computing device 110, a training computing system 150, and a server computing system 130, and each device and system are communicatively connected through a network 170.

According to various embodiments of the present disclosure, 1) the user computing device 110 can pre-train a vision-language transformer 120 locally and execute an application including the learned vision-language transformer 120, 2) the server computing system 130 communicating with the user computing device 110 can pre-train the vision-language transformer 120 or/and 140 and provide the vision-language transformer 120 or/and 140 and/or an application including the vision-language transformer 120 or/and 140 directly or in the form of a web service to the user computing device 110, and 3) the user computing device 110 and the server computing system 130 can be linked to each other to pre-train the vision-language transformer 120 or/and 140 or execute the pre-trained vision-language transformer 120 or/and 140 to provide various application services.

In addition, according to various embodiments of the present disclosure, the user computing device 110 and/or the server computing system 130 can train the vision-language transformed 120 through interaction with the training computing system 150 that is communicatively connected via the network 170. In this case, the training computing system 150 can be separate from the server computing system 130 or can be a part of the server computing system 130.

That is, the method for pre-training the vision-language transformer according to the embodiment can be such that 1) the user computing device 110 can pre-train the vision-language transformer 120 directly locally, 2) the server computing system 130 and the user computing device 110 can interact with each other via the network and pre-train, and 3) a separate training computing system 150 can pre-train the vision-language transformer using various training techniques and learning techniques.

Moreover, the training computing system 150 can be implemented in a manner that transmits the pre-trained vision-language transformer 120 or/and 140 to the user computing device 110 or/and the server computing system 130 through a network to provide or/and update the pre-trained vision-language transformer.

In some embodiments, the training computing system 150 can be part of the server computing system 130 or part of the user computing device 110.

In addition, the present disclosure discloses the method and system for pre-training a vision-language transformer that can be included in an application that performs various downstream tasks such as fine-tuning the pre-trained vision-language transformer.

The user computing device 110 can include any type of computing device, such as a smart phone, a mobile phone, a digital broadcasting device, a personal digital assistant (PDA), a portable multimedia player (PMP), a desktop, a wearable device, an embedded computing device, and/or a tablet PC.

The user computing device 110 can include at least one processor 111 and memory 112. Here, the processor 111 can be composed of at least one among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of processors electrically connected.

The memory 112 can include one or more non-transitory/transitory computer-readable storage media such as RAM, ROM, EEPROM, EPROM, flash memory devices, magnetic disks, and combinations thereof, and can include web storage of a server that performs a storage function of memory on the Internet. The memory 112 can store data 113 and instructions 114 necessary for the at least one processor 111 to perform operations such as pre-training the vision-language transformer 120 or executing the application including the pre-trained vision-language transformer 120.

In one embodiment, the user computing device 110 can store at least one machine learning model (that is, vision-language transformer 120).

In detail, the vision-language transformer 120 of one embodiment can be various machine learning models such as a plurality of neural networks (for example, Deep neural networks) or other types of machine learning models including nonlinear models and/or linear models, and can be composed of a combination of these.

Moreover, the neural networks can include at least one of feed-forward neural networks, recurrent neural networks (for example, long short-term memory recurrent neural networks), convolutional neural networks, or/and other types of neural networks.

In one embodiment, the user computing device 110 can receive at least one vision-language transformer 120 from the server computing system 130 through the network 170, store the received vision-language transformer 120 in memory, and then execute the stored vision-language transformer 120 by the processor 111 to operate an application having various vision-based tasks.

In another embodiment, the server computing system 130 can include at least one machine learning model (for example, vision-language transformer 140) to perform operations via the vision-language transformer 140, and can provide a user with an artificial intelligence system that performs various tasks using the vision-language transformer 140 in conjunction with the user computing device 110 by communicating data related thereto with the user computing device 110. For example, the user computing device 110 may perform vision tasks including the vision-language transformer 140 in a manner that the server computing system 130 provides output for the user's input using the vision-language transformer 140 via the web. In addition, the vision-language transformers 120 or/and 140 may be implemented in such a way that at least one of the vision-language transformers 120 or/and 140 is executed on the user computing device 110 and the other is executed on the server computing system 130.

In addition, the user computing device 110 can include at least one input component that detects user input. For example, the user input component can include a touch sensor (for example, a touch screen or/and a touch pad, or the like) that detects touch of the user's input medium (for example, a finger or a stylus), an image sensor that detects user motion input, a microphone that detects user voice input, a button, a mouse, and/or a keyboard, or the like. In addition, the user input component can include an interface and an external controller when receiving input to an external controller (for example, a mouse, a keyboard, or the like) through the interface.

The server computing system 130 includes at least one processor 131 and a memory 132. Here, the processor 131 can be composed of at least one among a central processing unit (CPU), a graphics processing unit (GPU), application specific integrated circuits programmable logic devices (PLDs), field programmable gate arrays (FPGAs), controllers, micro-controllers, microprocessors, and/or other electrical units for performing functions, or a plurality of processors electrically connected.

Moreover, the memory 132 can include one or more non-transitory/transitory computer-readable storage media such as RAM, ROM, EEPROM, EPROM, flash memory devices, magnetic disks, and combinations thereof. The memory 132 can store data 133 and instructions 134 necessary for the processor 131 to pre-train the vision-language transformer 140 or perform various vision tasks (for example, image detection, classification, segmentation, or the like) using the vision-language transformer 140.

In one embodiment, the server computing system 130 can be implemented including at least one computing device. For example, the server computing system 130 can be implemented to operate a plurality of computing devices according to a sequential computing architecture, a parallel computing architecture, or a combination thereof. In addition, the server computing system 130 can include a plurality of computing devices connected to a network.

In addition, the server computing system 130 can store at least one vision-language transformer 140. For example, the server computing system 130 can include a neural network or/and other multi-layer nonlinear models as the vision-language transformer 140. The exemplary neural network can include a feed-forward neural network, a deep neural network, a recurrent neural network, and a convolutional neural network.

The training computing system 150 can include at least one processor 151 and a memory 152. Here, the processor 151 can be composed of at least one among a central processing unit (CPU), a graphics processing unit (GPU), application specific integrated circuits programmable logic devices (PLDs), field programmable gate arrays (FPGAs), controllers, micro-controllers, microprocessors, and/or other electrical units for performing functions, or a plurality of processors electrically connected.

Moreover, the memory 152 can include one or more non-transitory/transitory computer-readable storage media such as RAM, ROM, EEPROM, EPROM, flash memory devices, magnetic disks, and combinations thereof. The memory 152 can store data 153 and instructions 154 necessary for the processor 151 to perform training of the vision-language transformer.

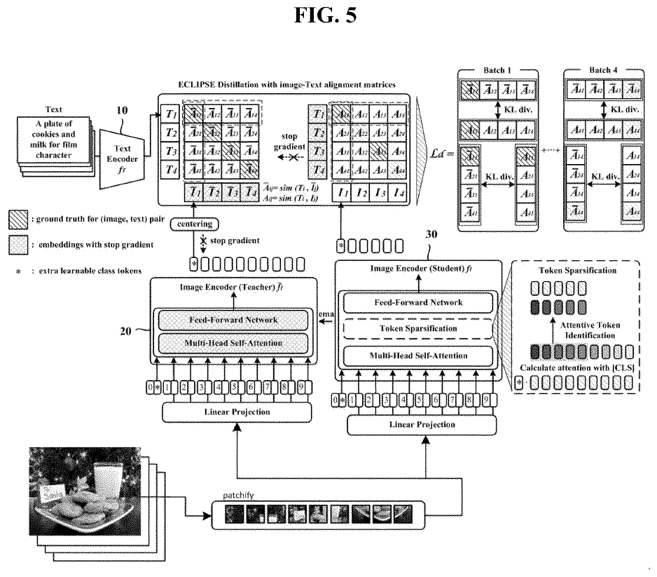

For example, the training computing system 150 can include a model trainer 160 that pre-trains the vision-language transformer 120 or/and 140 stored in the user computing device 110 or/and the server computing system 130 using various training or learning techniques, such as backpropagation of errors (according to the framework illustrated in FIG. 5).

For example, the model trainer 160 can perform updates of one or more parameters of the vision-language transformer 120 or/and 140 in a backpropagation manner based on a defined loss function.

In some implementations, performing backpropagation of errors can include performing truncated backpropagation through time. The model trainer 160 can perform a number of generalization techniques (for example, weight reduction, dropout, knowledge distillation, or the like) to improve the generalization ability of the vision-language transformer 120 or/and 140 being trained.

In particular, the model trainer 160 can train the vision-language transformer 120 or/and 140 based on a set of training data. The training data can include data of different multi-modal modalities, such as images, audio samples, text, or the like. Examples of image types that can be used can include everything from typical RGB images to video frames, LiDAR point clouds, X-ray images, computed tomography scans, hyperspectral images, and/or various other forms of images.

Such trainer data and input data for downstream tasks can be provided by the user computing device 110 or/and the server computing system 130. When the training computing device trains the vision-language transformer 120 for specific data of the user computing device 110, the vision-language transformer 120 can be characterized as a personalized model.

Moreover, the model trainer 160 can include computer logic utilized to provide a desired function. The model trainer 160 can be implemented as hardware, firmware, and/or software that controls a general-purpose processor. For example, in one embodiment, the model trainer 160 can include a program file stored on a storage device, loaded into memory, and executed by one or more processors. In another implementation, the model trainer 160 includes one or more sets of computer-executable instructions stored on a tangible computer-readable storage medium, such as a RAM hard disk or an optical or magnetic medium.

The network 170 can include, but is not limited to, a 3rd Generation Partnership Project (3GPP) network, a Long Term Evolution (LTE) network, a World Interoperability for Microwave Access (WIMAX) network, the Internet, a Local Area Network (LAN), a Wireless Local Area Network (WLAN), a Wide Area Network (WAN), a Personal Area Network (PAN), a Bluetooth network, a satellite broadcasting network, an analog broadcasting network, and/or a Digital Multimedia Broadcasting (DMB) network.

In general, communication over the network 170 can be performed using any type of wired and/or wireless connection, using various communication protocols (for example, TCP/IP, HTTP, SMTP, FTP), encodings or formats (for example, HTML, XML), and/or protection schemes (for example, VPN, Secure HTTP, SSL).

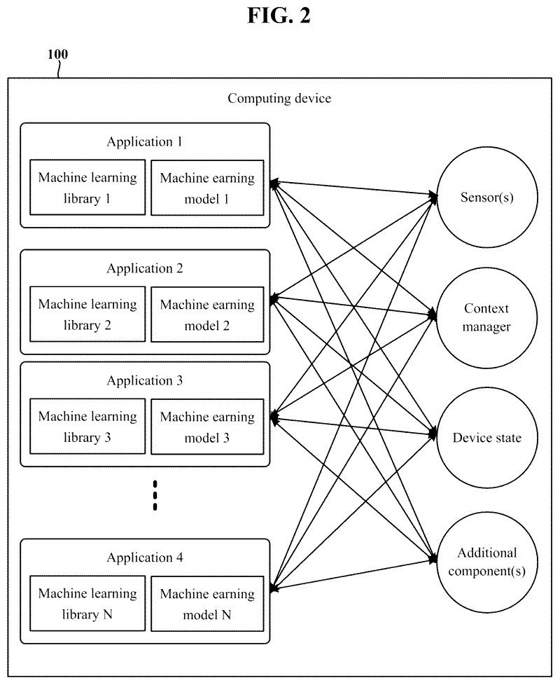

FIG. 2 illustrates an example block diagram of a computing device that pre-trains the vision-language transformer according to a knowledge distillation framework according to one embodiment of the present disclosure and executes the pre-trained vision-language transformer.

In FIG. 2, a computing device 100 included in the user computing device 110, the server computing system 130, and the training computing system 150 includes a plurality of applications (for example, application 1 to application N). Each application may include a machine learning library and one or more vision-language transformers. For example, the applications may include a vision task (for example, detection, classification, segmentation, or the like) application, a text messaging application including the vision task, an email application, a dictation application, a virtual keyboard application, a browser application, a chat-bot application, or the like.

In one embodiment, the computing device 100 can include the model trainer 160 for pre-training the vision-language transformer, and can store and operate the pre-trained vision-language transformer to perform various vision tasks using the vision-language transformer on input data.

Each application of the computing device 100 may communicate with a number of other components of the computing device 100, such as, for example, one or more sensors, a context manager, a device state component, and/or additional components. In one embodiment, each application may communicate with each device component using an API (for example, a public API). In one embodiment, the API used by each application may be specific to that application.

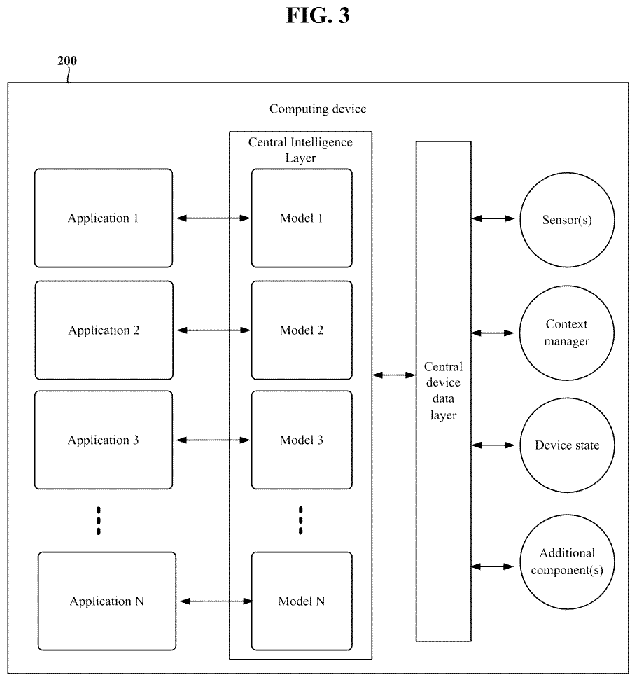

FIG. 3 illustrates an example block diagram of another aspect of a computing device 200 that pre-trains the vision-language transformer through a knowledge distillation framework according to one embodiment of the present disclosure and executes the pre-trained vision-language transformer.

Referring to FIG. 3, the computing device 200 includes a plurality of applications (for example, application 1 to application N). Each application can communicate with a central intelligence layer. For example, the applications can include an image processing application, a text messaging application, an email application, a dictation application, a virtual keyboard application, a browser application, or the like. In one embodiment, each application can communicate with the central intelligence layer (and the models stored therein) using an API (for example, a common API across all applications).

Moreover, the central intelligence layer can include a plurality of vision-language transformers. For example, as illustrated in FIG. 3, at least some of the vision-language transformers can be provided for each application and managed by the central intelligence layer. In other implementations, two or more applications can share a single vision-language transformer. For example, in some implementations, the central intelligence layer can provide a single model for all applications. In some implementations, the central intelligence layer can be included within the operating system of the computing device 200 or implemented differently.

The central intelligence layer can communicate with a central device data layer. The central device data layer can be a centralized data storage for the computing device 200. As illustrated in FIG. 3, the central device data layer can communicate with a number of other components of the computing device 200, such as, for example, one or more sensors, a context manager, a device state component, and/or additional components. In some implementations, the central device data layer can communicate with each device component using an API (for example, a private API).

The techniques described herein can reference servers, databases, software applications, and other computer-based systems, as well as actions taken and information transmitted to or from such systems. It will be appreciated that the inherent flexibility of computer-based systems allows for a wide range of possible configurations, combinations, and division of work and functionality between and among components. For example, the processes described herein can be implemented using a single device or component or multiple devices or components operating in combination. The database and applications can be implemented in a single system or in a distributed system across multiple systems. The distributed components can operate sequentially or in parallel.

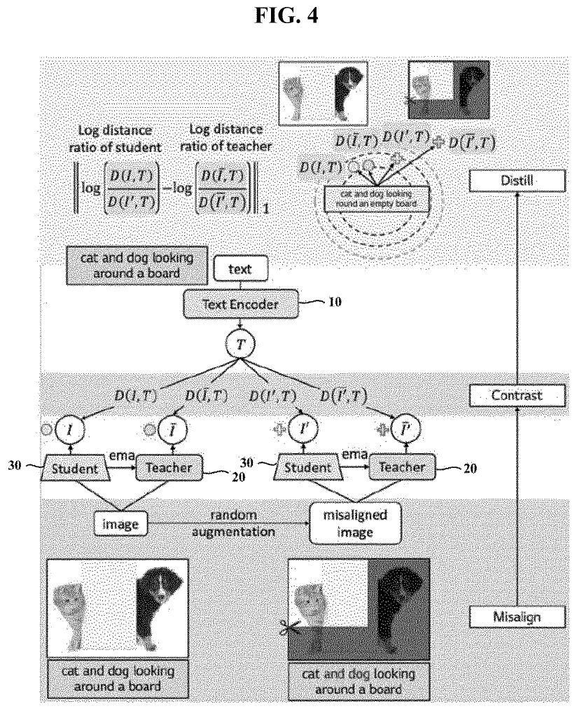

Hereinafter, the process of pre-training the vision-language transformer according to the knowledge distillation framework with a dataset augmented through random image enlargement by the computing system 1000 is described in detail with reference to FIGS. 4 to 6.

The vision-language transformer described in the present disclosure refers to a vision-language-based artificial intelligence model (VLM) pre-trained with a large-scale dataset for joint representation of two heterogeneous data types of vision-language (image-text) pairs.

The vision-language transformer according to this embodiment may include a single-stream model that transforms input data that combines images and text, and a dual (multi)-stream model that processes image-text through separate image encoders and text encoders.

In the following embodiments, for the convenience of the work, a vision-language transformer having a dual-stream architecture that pre-trains with a contrastive target on a dataset in which images and texts are matched is described.

The method for pre-training the vision-language transformer according to an embodiment can facilitate the pre-training of a dataset of contrastive image-text pairs by using a knowledge-distilled encoder based on a plurality of augmented image-text pairs obtained through image random augmentation.

Referring to FIGS. 4 and 5, a vision-language transformer pre-training architecture according to an embodiment includes a text encoder 10, a teacher image encoder 20, and a student image encoder 30. In addition, the student image encoder 30 and the teacher image encoder 20 may include a multi-head self-attention layer and a feed-forward network. In addition, the student image encoder 30 may further include a token sparsification layer.

Here, the image-text dataset for pre-training is an uncurated dataset, meaning data on which, for example, labeling tasks or captioning tasks have not been performed.

In an embodiment, in order to clearly verify the efficiency of the method for pre-training the vision-language transformer, at least one of Conceptual Captions (CC) 3M, Yahoo Flickr Creative Commons (YFCC) 15M, and YFCC15M, 88M, which are the large-scale open-source datasets, can be included as a dataset for pre-training.

In addition, as a downstream dataset for verifying the performance of the pre-trained vision-language transformer according to the present embodiment, zero-shot image-text from Flickr30K or/and MS-COCO may be included.

In particular, the computing system 1000 according to an embodiment of the present disclosure can prepare a plurality of image-text pairs in which image data (hereinafter, “image”) and text data (hereinafter, “text”), which are labels for the images, are paired as a pre-training dataset.

Moreover, the computing system 1000 can generate an augmented image by randomly augmenting the original image to increase the diversity of the dataset and improve the generalization ability of the vision-language transformer.

The computing system 1000 according to an embodiment may generate a plurality of augmented images by applying image random enlargement (for example, random crop, random rotation, random flip, color jittering, or/and random grayscale) during image augmentation, in particular, to intentionally cause incorrect alignment between the augmented image and the text.

The computing system 1000 can additionally generate a plurality of augmented images by applying a method of masking a random portion of the image.

In this way, the additional augmented image generated through random image augmentation can cause serious defects in the text pairs of the original image. Hereinafter, a simple theoretical basis for this is presented.

First, a text feature vector T, an original image feature vector I, and an augmented image feature vector I′ are formulated as a Markov Chain T→I→I′, which means that I′ depends only on the original image I.

According to a data processing inequality theory that data processing cannot increase the amount of information, a following formula may be derived.

$$ℐ ( I , T ) \geq ℐ ( {I}^{′} , T ) \qquad [ Mathematical Expression 1 ]$$

Here, [symbol] (⋅) represents mutual information, and the case where the two pieces of information are identical is only when the image I and the augmented image I′ are captured identically and contain the same information about the text T.

The computing system 1000 according to the embodiment proposes a new method that utilizes the information imbalance of the original image-text pair and the augmented image-text pair as learning information.

FIG. 4 conceptually illustrates the framework of the MCD pre-training method according to the embodiment of the present disclosure.

Referring to FIG. 4, the computing system 1000 according to the embodiment may perform pre-training of the image encoders 20 and 30 and the text encoder 10 by 1) augmenting the original image as described above to generate the plurality of augmented images to generate the original image-text pair and the augmented image-text pair, 2) inputting the original image-text pairs and the plurality of augmented image-text pairs into the teacher image encoder 20, the student image encoder 30, and the text encoder 10, respectively, to output feature vector representations for the image-text pairs, 3) projecting the output image feature representation vectors and the text feature representation vectors according to contrastive objectives to obtain the distance between the feature representation vectors, and 4) distilling the knowledge of the teacher image encoder 20 into the student image encoder 30 based on the obtained distance.

The MCD pre-training process will be described in more detail below.

First, the computing system 1000 may randomly enlarge or/and mask the original image to generate the plurality of augmented images.

Next, the framework of the MCD pre-training method includes the momentum teacher image encoder 20, the student image encoder 30, and the text encoder 10, as illustrated in FIG. 4, and may distill the knowledge of the teacher image encoder 20 into the student image encoder 30 based on the stop gradient.

Here, the momentum teacher image encoder 20 is the teacher image encoder 20 whose model parameters are updated more slowly over time, and may stably train the student image encoder 30.

Moreover, the student image encoder 30 may be a relatively simple (for example, with fewer parameters) machine learning model compared to the teacher image encoder 20 trained to imitate the operation of the teacher image encoder 20.

The teacher and student image encoders 30 are trained to convert the original image and the augmented image into feature representations, and may output image feature vector representations of the input image.

Here, the feature vector representation means a vector representing the features of the image object in n dimensions, and may be called an embedding as a feature vector that combines several features of the converted object into a format that can be processed by the machine learning model and converted into a structured form.

Finally, the text encoder 10 is an encoder that outputs a text feature vector representation T when text is input. In detail, the text encoder 10 can be trained to convert the features of the text into feature representations, and can output a text feature vector representation T for the input text.

The computing system 1000 can obtain a first image feature vector representation including an original image feature vector representation (bar I) and an augmented image feature vector representation (bar I′) by inputting the original image and the augmented image to the teacher image encoder 20.

In addition, the computing system 1000 can obtain a second image feature vector representation including the original image feature vector representation I and the augmented image feature vector representation I′ by inputting the original image and the augmented image into the student image encoder 30.

In addition, the computing system 1000 may obtain the text feature vector representation T by inputting the text matched to the original image into the text encoder 10.

Next, the computing system 1000 may generate a first alignment matrix (bar A) by mapping the text feature vector representations T and the first image feature vector representations output from the teacher image encoder 20 according to the matched positive pairs and the unmatched negative pairs.

Moreover, the computing system 1000 may learn the teacher image encoder 20 and the text encoder 10 by a method (for example, InfoNCE loss (a method of training to maximize the similarity of positive pairs and minimize the similarity of negative pairs)) of aligning the first alignment matrix (bar A) based on the similarity comparison criteria of the output text feature vector representations T and the first image feature vector representations based on the mapped positive/negative criteria.

In this case, in a process of training the first alignment matrix (bar A) composed of the first image feature vector representations for similarity alignment, the teacher image encoder 20 may be a momentum teacher with stop gradient momentum model, and thus, the computing system 1000 may block backpropagation (sg) to the teacher image encoder 20 during similarity alignment learning.

Thereafter, the computing system 1000 can learn according to the loss function so that the spatial distance between positive feature vector representations becomes closer for similarity alignment and the spatial distance between negative feature vector representations becomes farther.

That is, the computing system can perform contrastive learning to define the loss function so that

$$\text{?}$$

$$\text{?} \text{indicates text missing or illegible when filed}$$

is satisfied.

For example, as described above, the computing system 1000 can learn the teacher image encoder 20 by contrastively learning the first alignment matrix (bar A) so that InfoNCE Loss which is the loss function is applied to the similarity matrix.

Moreover, the computing system 1000 can input the original image and the augmented image into the student image encoder 30 to output the second image feature vector representations.

In this case, the student image encoder 30 can accelerate the pre-training by reconstructing the patch tokens by including the token sparsification layer. However, the token sparsification layer may be omitted.

In detail, the student image encoder 30 can calculate (self-attention) the attention value between images and discard tokens below a predetermined standard according to the attention value between the images calculated.

For example, the student image encoder 30 can discard inattentive tokens according to a fixed ratio (1-K) according to the attention value between patches of the 4th, 7th, and 10th transformer layers among the self-attention layers. Here, K is a token retention rate.

Moreover, the computing system 1000 may generate a second alignment matrix A by mapping the text feature vector representations T and the second image feature vector representations according to the matched positive pairs and the unmatched negative pairs.

Next, the computing system 1000 can perform knowledge distillation so that the second alignment matrix A predicts the output value of the first alignment matrix (bar A) aligned according to the similarity mapping, unlike the conventional knowledge distillation method.

That is, the computing system 1000 can perform the knowledge distillation by training the student image encoder 30 so that the second alignment matrix A is aligned by soft-aligning the first alignment matrix (bar A).

In this case, the text encoder 10 and the teacher image encoder 20 can be a momentum model with a stop gradient that blocks backpropagation (sg) to the text encoder 10 during the knowledge distillation.

In detail, the computing system 1000 can learn the parameters of the student image encoder 30 to perform the knowledge distillation so that the second alignment matrix A is aligned according to the first alignment matrix (bar A).

Moreover, the computing system 1000 can update the parameters of the teacher image encoder 20 with an exponential moving average (EMA) based on the parameters of the student image encoder 30.

In this case, the computing system 1000 can perform the knowledge distillation by defining the loss function based on the distance between the image feature vector representation and the text feature vector representation T in order to perform the knowledge distillation by reflecting the misalignment information between the augmented image and the text as described above.

In detail, the computing system 1000 can calculate a first Euclidean distance between the original image feature vector representation I and the text feature vector representation T output by the student image encoder 30, and a second Euclidean distance between the augmented image feature vector representation I′ and the text feature vector representation T output by the student image encoder 30, and calculate a first ratio of the first Euclidean distance and the second Euclidean distance, and at this time, a log scale may be applied. That is, the first ratio may be calculated in a log scale to calculate the first log ratio.

In addition, the computing system 1000 can calculate a third Euclidean distance between the original image feature vector representation (bar I) and the text feature vector representation T output by the teacher image encoder 20, and a fourth Euclidean distance between the augmented image feature vector representation (bar I′) and the text feature vector representation T output by the teacher image encoder 20, and calculate a second ratio of the third Euclidean distance and the fourth Euclidean distance, and at this time, a log scale may be applied. That is, the second ratio may be calculated in a log scale to calculate the second log ratio.

In addition, the computing system 1000 can teach the encoder by defining the difference between the first log ratio and the second log ratio as the loss function for aligning the second alignment matrix to approximate the first alignment matrix (bar A).

Below, the calculation process for the above pre-training is described in detail through specific Mathematical Expression.

Specifically, a first alignment matrix Āᵢⱼ and a second alignment matrix Aᵢⱼ for a function ƒ̅_{I} for the momentum teacher image encoder 20 with stop gradient, a function ƒ_{T} for the momentum text encoder 10 with stop gradient, and a function ƒ_{I} for the student encoder may be defined as in the following Mathematical Expression 2.

$${\overline{A}}_{ij} = sim ( {T}_{i} , sg ( {\overline{I}}_{j} ) ) , {A}_{ij} = sim ( sg ( {T}_{i} , {I}_{j} ) \qquad [ Mathematical Expression 2 ]$$

Here, sg is the stop gradient,

$${\overline{I}}_{j} \vert = {\overline{f}}_{I} ( {x}_{j}^{I} ) and {I}_{j} \vert = {f}_{I} ( {x}_{j}^{I} )$$

are the image feature vector representations for the jth image using the teacher image encoder 20 and the student image encoder 30, respectively,

$${T}_{i} = {f}_{T} ( {x}_{i}^{T} )$$

is the text feature vector representations T for the ith text, and sim means the cosine similarity function.

Moreover, as mentioned above, the InfoNCE loss function can be defined and pre-trained based on the distance between the original image feature vector representation (I, bar I) and the augmented image feature vector representation (I′, bar I′) and the text feature vector representation T, and this process is explained through Mathematical Expressions 3 to 6.

In addition, the computing system 1000 may define a loss function for aligning the first alignment matrix (bar A) and the second alignment matrix A using the InfoNCE loss (Mathematical Expression 3).

$$\text{?} = {‖ log \frac{D ( \text{?} , \text{?} )}{D ( \text{?} , \text{?} )} - log \frac{D ( \text{?} , \text{?} )}{D ( \text{?} , \text{?} )} ‖}_{\text{?}} \qquad [ Mathematical Expression 3 ]$$

$$\text{?} \text{indicates text missing or illegible when filed}$$

Here, [symbol] ᵢ means InfoNCE loss, D(v, u) means the Euclidean distance between vectors and vectors, and can be calculated through cosine similarity.

Therefore, D(Iⱼ,Tᵢ) is the first Euclidean distance,

$$D ( {I}_{j}^{′} , {T}_{i} )$$

is the second Euclidean distance, D(Īⱼ,Tᵢ) is the third Euclidean distance, and

$$D ( {\overline{I}}_{j}^{′} , {T}_{i} )$$

is the fourth Euclidean distance.

Specifically, in the embodiment, the original image feature vector Iᵢ and the text feature vector Tⱼ are L2 normalized vectors, and the Euclidean distance can be calculated through D(Iᵢ,Tⱼ)=2(1−Aᵢⱼ) which is the cosine similarity function.

Next, the computing system 1000 can gradually distill the knowledge of the teacher image encoder 20 into the student image encoder 30 based on the above loss function.

In detail, the computing system 1000 can perform the knowledge distillation to predict that the second alignment matrix and the first alignment matrix are identical.

In detail, the distillation loss is defined as the KL divergence for each row and column between the first alignment matrix (bar A) and the second alignment matrix A. In detail, the overall distillation loss is the average of the KL losses for the row vector and the column vector, and thus can be defined as in the following Mathematical Expression 5.

$${ℒ}_{student} = {ℒ}_{CLIP} ( A ) + λ {ℒ}_{distill} ( \overline{A} , A ) \qquad [ Mathematical Expression 5 ]$$

In this case, the computing system 1000 may balance [symbol] _{distill} which is the loss of the conventional knowledge distillation method and [symbol] _{CLIP}(A) which is the InfoNCE loss as in Mathematical Expression 6 in order to accelerate the training of the student image encoder 30.

$${ℒ}_{student} = {ℒ}_{CLIP} ( A ) + λ {ℒ}_{distill} ( \overline{A} , A ) \qquad [ Mathematical Expression 6 ]$$

Here, λ is a parameter that balances the KL divergence loss and the InfoNCE loss, and is set based on the exponential moving average (ema) in the embodiment.

Therefore, [symbol] which is the final loss of the MCD pre-training may be calculated as in Mathematical Expression 7.

$$ℒ = {ℒ}_{student} + {ℒ}_{CLIP} ( \overline{A} ) \qquad [ Mathematical Expression 7 ]$$

Moreover, as described above, the parameters of the encoders 10 and 20 may be updated through the stop gradient to prevent backpropagation in the teacher image encoder 20 and the text encoder 10.

In detail, θ_{ƒ}_{_{I}} and θ_{ƒ̅}_{_{I}} represent the parameters of the student encoder and the momentum teacher image encoder 20, respectively, and the update of

$${θ}_{{\overline{f}}_{I}}^{( t )}$$

may be performed according to the following Mathematical Expression 8 at the tth step.

$${θ}_{{\overline{f}}_{I}}^{( t )} = m {θ}_{{\overline{f}}_{I}}^{( t - 1 )} + ( 1 - m ) {θ}_{{f}_{I}}^{( t )} \qquad [ Mathematical Expression 8 ]$$

As a result of the experiment, the most efficient training could be performed when m was 0.994.

Below, an explanation is given to compare the effectiveness of the vision-language transformer learned through MCD pre-training according to the embodiment of the present disclosure with the conventional technology.

The artificial intelligence system including the vision-language transformer of the present disclosure can perform vision tasks such as image classification, segmentation, object detection, image generation, automatic caption generation, image search, and image description with relatively high accuracy compared to the conventional transformer.

Table 1 below compares the zero-shot image classification performance of the MCD model obtained by pre-training the vision-language transformer model with the MCD pre-training method for the YFCC15M dataset, which includes 11 downstream datasets, and the vision-language transformer model trained with the conventional technology on the YFCC15M dataset. In this case, whether additional supervision other than contrast loss for image-text pairs was performed is expressed as S: SSL between augmentations, E: text augmentation, N: nearest neighbor, L: masked language modeling, I: augmented information encoded with additional embedding layer X.

TABLE 1

| | | | | | | | | | |
|---|---|---|---|---|---|---|---|---|---|
| | Additional | Vision | Oxford | | | | | | |
| Method | Supervision | Encoder | Pets | CIFAR-10 | CIFAR-100 | SUN397 | Food-101 | Flowers | Cats |

Zero-shot Classification:

| | | | | | | | | | |
|---|---|---|---|---|---|---|---|---|---|
| CLIP [14] | — | | 19.4 | 62.3 | 33.6 | 40.2 | 33.7 | 6.3 | 2.1 |
| SLIP [11] | S | | 28.3 | 72.2 | 45.3 | 45.1 | 44.7 | 6.8 | 2.9 |
| DeCLIP [10] | S + E + N + L | ViT-B/32 | 30.2 | 72.1 | 39.7 | 51.6 | 46.9 | 7.1 | 3.9 |
| UniCLIP [9] | S + I + X | | 32.5 | 78.6 | 47.2 | 50.4 | 48.7 | 8.1 | 3.4 |
| MCD (Ours) | S | | 36.8 | 80.1 | 48.4 | 51.9 | 49.6 | 8.1 | 3.7 |

Linear Probing:

| | | | | | | | | | |
|---|---|---|---|---|---|---|---|---|---|
| CLIP [14] | — | | 71.2 | 89.2 | 72.1 | 70.1 | 71.4 | 93.2 | 34.9 |
| SLIP [11] | S | | 75.4 | 90.5 | 75.3 | 73.5 | 77.1 | 96.1 | 43.0 |
| DeCLIP [10] | S + E + N + L | ViT-B/32 | 76.5 | 88.6 | 71.6 | 75.9 | 79.3 | 96.7 | 42.6 |
| UniCLIP [9] | S + I + X | | 83.1 | 92.5 | 78.2 | 77.0 | 81.3 | 97.1 | 49.8 |
| MCD (OMS) | S | | 85.6 | 92.3 | 79.3 | 77.6 | | | |

| | | | | | | | |
|---|---|---|---|---|---|---|---|
| | Additional | Vision | | | | | |
| Method | Supervision | Encoder | Caltech-101 | Aircraft | DTD | ImageNet | Average |

Zero-shot Classification:

| | | | | | | | |
|---|---|---|---|---|---|---|---|
| CLIP [14] | — | | 55.4 | 1.4 | 16.9 | 31.3 | 27.5 |
| SLIP [11] | S | | 65.9 | 1.9 | 21.8 | 38.3 | 33.9 |
| DeCLIP [10] | S + E + N + L | ViT-B/32 | 70.1 | 2.5 | 24.2 | 41.2 | 35.4 |
| UniCLIP [9] | S + I + X | | 73.0 | 2.8 | 23.3 | 42.8 | 37.3 |
| MCD (Ours) | S | | 73.1 | 2.7 | 28.8 | 43.4 | 38.7 |

Linear Probing:

| | | | | | | | |
|---|---|---|---|---|---|---|---|
| CLIP [14] | — | | 84.3 | 29.7 | 60.9 | 61.1 | 67.1 |
| SLIP [11] | S | | 87.2 | 34.1 | 71.1 | 68.1 | 71.9 |
| DeCLIP [10] | S + E + N + L | ViT-B/32 | 88.0 | 32.6 | 69.1 | 69.2 | 71.8 |
| UniCLIP [9] | S + I + X | | 88.9 | 36.2 | 72.8 | 70.8 | 75.2 |
| MCD (OMS) | S | | | | | 71.3 | |

As can be seen from the table above, the MCD model that performed only the SSL between augmentations shows superior performance compared to the conventional model in 9 out of 11 downstream datasets, and the average value is also significantly improved.

Therefore, the computing system 1000 can perform various artificial intelligence tasks by executing various applications including the vision-language transformer that has excellent performance for these vision tasks.

Moreover, the framework utilizing the token sparsification and knowledge distillation for this contrastive language-image pre-training can be extended and applied to pre-training for the additional forms such as audio at the level of ordinary technicians.

The embodiments according to the present disclosure described above can be implemented in the form of program instructions that can be executed through various computer components and recorded on a computer-readable recording medium. The computer-readable recording medium can include program instructions, data files, data structures, or the like, alone or in combination. The program instructions recorded on the computer-readable recording medium can be specially designed and configured for the present disclosure or can be known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program instructions such as ROMs, RAMs, and flash memories. Examples of program instructions include not only machine language codes, such as those produced by a compiler, but also high-level language codes that can be executed by a computer using an interpreter, or the like. A hardware device may be changed into one or more software modules to perform processing according to the present disclosure, and vice versa.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A computer-implemented method, comprising:
outputting a first vision feature vector representation by inputting at least one piece of vision data and at least one augmented data based on the at least one piece of vision data into at least one artificial intelligence model;
outputting a second vision feature vector representation from which a portion of image information having relatively low information importance is removed by inputting the at least one piece of vision data and the at least one augmented data into at least one artificial intelligence model comprising a token sparsification layer;
generating a first alignment matrix for a text feature vector representation for text mapped to the at least one piece of vision data and the first vision feature vector representation;
training the first alignment matrix so that the text feature vector representation and the first vision feature vector representation are aligned to have similarity according to positive and negative mapping relationships of the image-text pair;
generating a second alignment matrix for the text feature vector representation and the second vision feature vector representation, and
performing knowledge distillation on the at least one artificial intelligence model comprising the token sparsification layer by aligning the second alignment matrix to predict the output of the trained first alignment matrix.

2. The method of claim 1, wherein the outputting of a second vision feature vector representation comprises:
acquiring output tokens generated by performing an attention operation on image patch tokens by inputting the at least one piece of vision data and the at least one augmented data into the at least one artificial intelligence model;
performing token sparsification by removing tokens having low importance at a fixed ratio by the token sparsification layer based on the output tokens from the at least one artificial intelligence model; and
outputting the second vision feature vector representation based on the tokens remaining after said token sparsification process.

3. The method of claim 1, further comprising:
generating the at least one augmented data by randomly augmenting the at least one piece of vision data; and
outputting the text feature vector representation by inputting text mapped to the at least one piece of vision data into at least one artificial intelligence model.

4. The method of claim 1, wherein the outputting of a first vision feature vector representation comprises:
outputting a first vision feature vector representation by inputting the at least one piece of vision data and the at least one augmented data to a plurality of self-attention layers and a plurality of feed-forward network layers.

5. The method of claim 1, wherein the training of the first alignment matrix includes:
determining a positive feature vector representation pair and a negative feature vector representation pair between the text feature vector representation and the first vision feature vector representation according to a mapping relationship between the at least one piece of vision data-text pair and the at least one augmented data-text pair, and
training the at least one artificial intelligence model outputting the first vision feature vector representation according to a loss function that makes a distance between the positive feature vector representation pair closer and a distance between the negative feature vector representation pair farther for similarity alignment.

6. The method of claim 5, wherein the training of the at least one artificial intelligence model outputting the first vision feature vector representation according to the loss function includes preventing backpropagation by applying a momentum stop gradient to the at least one artificial intelligence model that outputs the first vision feature vector representation during training for similarity alignment according to the loss function.

7. The method of claim 6, wherein the performing of the knowledge distillation on the at least one artificial intelligence model comprising the token sparsification layer includes performing knowledge distillation so that the output value of the first alignment matrix according to the similarity alignment is predicted by the second alignment matrix.

8. The method of claim 7, wherein the performing of the knowledge distillation on the second alignment matrix includes blocking backpropagation to the at least one artificial intelligence model that outputs the text feature vector representation by receiving text mapped to the at least one piece of vision data during the knowledge distillation.

9. The method of claim 8, wherein the performing of the knowledge distillation on the second alignment matrix includes performing knowledge distillation so that a parameter of the second alignment matrix follows a parameter of the first alignment matrix.

10. The method of claim 9, wherein the performing of the knowledge distillation so that the parameter of the second alignment matrix follows the parameter of the first alignment matrix includes updating the parameter of the first alignment matrix with an exponential moving average (EMA) based on the parameter of the second alignment matrix.

11. The method of claim 1, wherein the performing of the knowledge distillation on the second alignment matrix includes defining a loss function that reflects misalignment information between the at least one augmented data and the text through a distance between the first vision feature vector representation and the text feature vector representation and a distance between the second image feature vector representation and the text feature vector representation.

12. The method of claim 11, wherein the performing of the knowledge distillation by defining the loss function based on the distances includes:
calculating a first Euclidean distance between the vision data feature vector representation output by the at least one artificial intelligence model comprising the token sparsification layer and the text feature vector representation, and a second Euclidean distance between the augmented data feature vector representation output by the at least one artificial intelligence model comprising the token sparsification layer and the text feature vector representation, and calculating a first log ratio that calculates a ratio of the first Euclidean distance and the second Euclidean distance in a log scale.

13. The method of claim 12, wherein the performing of the knowledge distillation by defining the loss function based on the distances includes:
calculating a third Euclidean distance between the vision data feature vector representation output by the at least one artificial intelligence model that outputs the first vision feature vector representation and the text feature vector representation, and a fourth Euclidean distance between the augmented data feature vector representation output by the at least one artificial intelligence model that outputs the first vision feature vector representation and the text feature vector representation, and calculating a second log ratio that calculates a ratio of the third Euclidean distance and the fourth Euclidean distance in a log scale.

14. The method of claim 13, wherein the performing of the knowledge distillation by defining the loss function based on the distances includes performing the knowledge distillation by defining a difference between the first log ratio and the second log ratio as a loss function for aligning the second alignment matrix to be approximate to the first alignment matrix.

15. The method of claim 14, wherein the loss function for aligning the first alignment matrix and the second alignment matrix is defined as
$$\text{?} = {‖ log \frac{D ( \text{?} , \text{?} )}{D ( \text{?} , \text{?} )} - log \frac{D ( \text{?} , \text{?} )}{D ( \text{?} , \text{?} )} ‖}_{\text{?}} .$$
$$\text{?} \text{indicates text missing or illegible when filed}$$

16. A computer-implemented method, comprising:
storing raw user data, input through at least one user interface, in at least one memory;
ingesting at least one data representation into at least one artificial intelligence model, wherein the at least one data representation comprises at least one of the raw user data itself or derived data derived from the raw user data by a pre-processing module, a feature extraction module, or another component configured to generate said data representation;
generating vision task data by performing a vision task based on the data representation using the at least one artificial intelligence model that is pre-trained, wherein the vision task is performed by at least one processor; and
ingesting the vision task data into at least one post-processing component;
wherein the at least one artificial intelligence model is pre-trained through a pre-training method comprising:
inputting at least one vision data and at least one augmented data based on the at least one vision data into the at least one artificial intelligence model; and
outputting a plurality of types of feature vector representations by the at least one artificial intelligence model;
wherein the generating vision task data comprises:
inputting the at least one data representation into the at least one artificial intelligence model comprising at least one attention layer, which is operated by said at least one processor; and
performing token processing based on the at least one data representation by the at least one artificial intelligence model which is operated by the at least one processor.

17. The method of claim 16, further comprising: manifesting the vision task data through at least one user interface by the post-processing component which is operated by the at least one processor.

18. The method of claim 16, wherein the at least one artificial intelligence model that is pre-trained is pre-trained by a method that includes being trained as a pair of at least two different artificial intelligence models;
the vision task further includes an additional task processed by at least one artificial intelligence model based on vision task data accepted from the at least one post-processing component; and
the artificial intelligence model that processes the additional task includes at least one of the at least one artificial intelligence model used in the ingesting at least one data representation step.

19. The method of claim 16, wherein the performing token processing comprises: performing at least one of pruning or sparsification on tokens having relatively low importance of the at least one data representation.

20. The method of claim 16, wherein said raw user data comprises at least one of user input data comprising at least one of voice or text, and at least one vision data

21. The method of claim 16, wherein the vision task includes at least one of visual question answering (VQA), image classification, object detection, image segmentation, image captioning, image analysis, and optical character recognition (OCR).

22. The method of claim 16, wherein the pre-training method comprises:
outputting a first vision feature vector representation by inputting at least one piece of vision data and at least one augmented data based on the at least one piece of vision data into at least one artificial intelligence model;
outputting a second vision feature vector representation from which a portion of image information having relatively low information importance is removed by inputting the at least one piece of vision data and the at least one augmented data into at least one artificial intelligence model comprising a token sparsification layer;
generating a first alignment matrix for a text feature vector representation for text mapped to the at least one piece of vision data and the first vision feature vector representation;
training the first alignment matrix so that the text feature vector representation and the first vision feature vector representation are aligned to have similarity according to positive and negative mapping relationships of the image-text pair,
generating a second alignment matrix for the text feature vector representation and the second vision feature vector representation, and
performing knowledge distillation on the at least one artificial intelligence model comprising the token sparsification layer by aligning the second alignment matrix to predict the output of the trained first alignment matrix.
